(19) United States
(12) Patent Application Publication
(10) Pub. No.: US 2010/0180160 A1
(43) Pub. Date: Jul. 15, 2010

(54) Communication System and Method for Monitoring and Remote Debugging

(75) Inventors: Wen-Yi KUO, TAIPEI CITY (TW); Chih-Ming LIN, Keelung City (TW); Jui-Ming YU, TAIPEI COUNTY (TW); Un Pio LEONG, TAIPEI CITY (TW)

Correspondence Address: BRIAN M. MCINNIS, 12th Floor, Ruttonjee House, 11 Duddell Street, Hong Kong, HK

(73) Assignee: BANDRICH INC., TAIPEI COUNTY (TW)

(21) Appl. No.: 12/651,384

(22) Filed: Dec. 31, 2009

Related U.S. Application Data
(60) Provisional application No. 61/144,747, filed on Jan. 15, 2009.

(51) Int. Cl. G06F 11/07; G06F 15/16

(52) U.S. Cl. 714/46; 709/202; 709/206; 714/E11.024; 714/E11.029

(57) ABSTRACT

A communication system and a method adapted in the communication system for monitoring and remote debugging are provided. The communication system comprises a server, at least one terminal device and a customer service team end. The terminal device is to generate a terminal device data, wherein the terminal device further sends the terminal device data either unsolicitedly or on demand to the server, wherein the data processor further generates report files according to the terminal device data. The customer service team end is to retrieve the terminal device data and the report file from the server for to monitoring and remote debugging.

### CROSS-REFERENCE TO RELATED APPLICATION

This application claims the priority benefit of U.S. Provisional Application Ser. No. 61/144,747, filed Jan. 15, 2009, which is herein incorporated by reference.

### BACKGROUND

1. Technical Field

The present disclosure relates to a system and method for communication. More particularly, the present disclosure relates to a communication system and a method adapted in the communication system for monitoring and remote debugging.

2. Description of Related Art

Cellular type wireless communication systems (GSM, GPRS, EDGE, WCDMA, HSPA, LTE, or cdma2000, EVDO, or TD-SCDMA, or WiMax, etc.) have made a significant business progress in our daily life. Most people are benefiting from such communication systems for better communication efficiency and timely critical data delivery. However, with mass deployment and usage, there is always need to debug the system problems—be it coverage issue, capacity issue, network quality issue, sudden network equipment failure, sudden power loss, sudden external interference, etc. Such a strong need in network debug, particularly from the end user perspective is very critical as such a communication service is now very vital for end users in their personal, social and business needs. Thus it is of essential need to have an integral remote debugging system that can meet both time and cost efficiency requirements from network management and end users. Traditional customer support service for such communication network problems requires a lot of man power and expenses on debug tasks such as making a large number of phone calls to coordinate on-site service, taking long travel to customer sites for testing, and sometimes installing expensive test equipments in end user site for test data collection, etc. Currently there is yet no satisfying approach, causing end to users to suffer from sluggish services.

### SUMMARY

A communication system is provided. The communication system comprises a server, at least one terminal device and a customer service team is end. The terminal device is to generate a terminal device data, wherein the terminal device further sends the terminal device data either unsolicitedly or on demand to the server, wherein the server further generates a report file according to the terminal device data. The customer service team end is to retrieve the terminal device data and the report file from the server for monitoring and remote debugging.

Another aspect of the present disclosure is to provide a method adapted in a communication system for monitoring and remote debugging. The method comprises the steps as follows. A terminal device data is generated from at least one terminal device of the communication system. The terminal device data is sent either unsolicitedly or on demand to a server of the communication system. A report file is generated according to the terminal device data. The terminal device data and the report file are retrieved from the server to a customer service team end for monitoring and remote debugging.

It is to be understood that both the foregoing general description and the following detailed description are by examples, and are intended to provide further explanation of the disclosure as claimed.

### BRIEF DESCRIPTION OF THE DRAWINGS

The disclosure can be more fully understood by reading the following detailed description of the embodiments, with reference made to the accompanying drawings as follows:

FIG. 1 is a diagram of the communication system of the present disclosure; and

FIG. 2 is a flow chart of the method for monitoring and remote debugging in an embodiment of the present disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

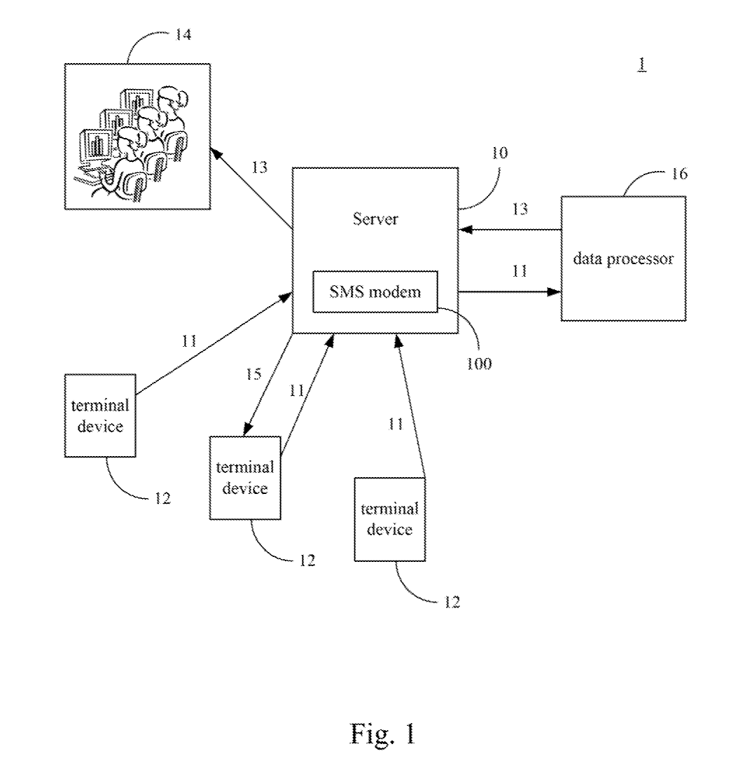

Please refer to FIG. 1. FIG. 1 is a diagram of a communication system 1 of the present disclosure. The communication system 1 comprises a server 10, terminal devices 12 and a customer service team end 14. Each terminal device 12 is to generate a terminal device data 11.

The terminal devices 12 can be a data modem, a handset, a mobile internet device, a notebook computer embedded with cellular function, a router embedded with cellular function or M2M devices, depending on different embodiments, that is able to communicate with the server 10. The terminal devices 12 are able to communicate with the server 10 through either a wireless network such as WiFi, GSM, GPRS, WCDMA, HSPA, LTE, WiMax and CDMA2000 or a cable network such as Ethernet network. The terminal device data 11 comprises, but are not limited to, a device information, a radio environment data, a plurality of user events, a measurement data, or a combination thereof. The device information may comprise time, IMEI, IMSI, modem hardware version, modem software version, PC OS version, PC model and connection profile. The radio environment data may comprise serving cell, PSC and GPS location. The user usage events may comprise login, logout, websites visited, service used and session statistics. The measurement data may comprise data throughput, 3G-specific measurements such as CQI, BLER, RSCP, Ec/lo, receive power, transmit power, happy rate (HSUPA), RTT and 2G-specific measurement such as RxQual, RxLevel, transmit power and TA.

In an embodiment, the terminal device 12 is not necessary to log the whole information described above. The terminal device 12 can be configured to log only the specific subsets of the full log information, depending on the usage scenario.

The terminal device 12 generates the terminal device data 11 either periodically or with an event-triggered mechanism. When the terminal device 12 is configured to generate the terminal device data 11 periodically, it can be scheduled in time when to generate. When the terminal device 12 is configured s to generate the terminal device data 11 with an event-triggered mechanism, the terminal device 12 may start to generate the terminal device data 11 according to local trigger events from such as user input, radio KPI (key performance indicator) thresholds, PC events or according to external events such as the reception of SMS (short message service) commands, or network commands. Besides, the terminal device 12 may start to generate the terminal device data 11 according to user service events and or usage events. For instance, the terminal device 12 may start to generate the terminal device data 11 when the terminal device 12 accesses some web-sites over certain times or when the usage of the terminal device 12 is over some threshold, or when the terminal device 12 uses certain type of services (e.g., banking), etc.

In an embodiment, the terminal device 12 can be programmed to generate and send the terminal device data 11 comprising data only within a period right before service events happen. For instance, the terminal device 12 may start to generate the terminal device data 11 and store locally in the device until when a network event happens, such as when a call drop happens, when channel quality degrades, when miss a page, when miss a call, when data connection speed is below a certain threshold, the terminal device 12 may send the last 3-5 minutes of terminal device data 11 back to the server 10.

It's noticed that not only the beginning of the generation of the terminal device data 11 can be triggered by the events described above, the termination of the generation of the terminal device data 11 can also be the event-trigger mechanism as described above to stop the generation of the terminal device data 11.

The communication system 1 of the present embodiment further comprises a data processor 16 to generate a plurality of analysis data 13 according to the terminal device data 11. The data processor 16 can be an independent device in the communication system 1 or be placed in the server 10, depending on different embodiments. The data processor 16 further generates a report file 13 according to the terminal device data 11. The report to file 13 may comprise, but is not limited to, a network performance analysis, a user behavior analysis, a usage analysis, a capacity analysis, or a combination thereof. In another embodiment, the server 10 itself is able to analyze the terminal device data 11 to further generate the report file 13. Thus, in such condition, the data processor 16 is not a necessary device. is In the present embodiment, the server 10 further comprises an SMS modem 100. The terminal device 12 is able to send the status information of the terminal device 12 to the server 10 using SMS via the SMS modem. The status information may comprise a testing state, a testing progress, a trouble report or a combination thereof. Upon receiving the status information, the server 10 is able to send an SMS to notify the customer service team end 14.

The customer service team end 14 is to retrieve the terminal device data 11 and the report file 13 from the server 10 for monitoring and remote debugging. Therefore, the customer service team end 14 is able to retrieve the information of each terminal device 12 to monitor the usage condition of the terminal device 12 or to debug if any unusual usage condition happens. The end users' permission to send back the terminal device data 11 can be verified through the UI software in the terminal device 12 or through customer service representatives' confirmation.

In the present embodiment, the customer service team end 14 is able to login to the server 10 to control the terminal device 12 by sending a command 15 to the terminal device 12. The server 10 can send the command 15 either using SMS through the SMS modem 100 or through a dedicated signaling channel, a paging channel, a forward access channel or a shared access channel. The command 15 is to request the terminal device 12 to send the terminal device data 11 to the server 10. Therefore, the customer service team end 14 does not need to wait for the terminal device 12 to send the terminal device data 11 and can obtain the necessary information at any time to perform trouble-shooting or monitoring.

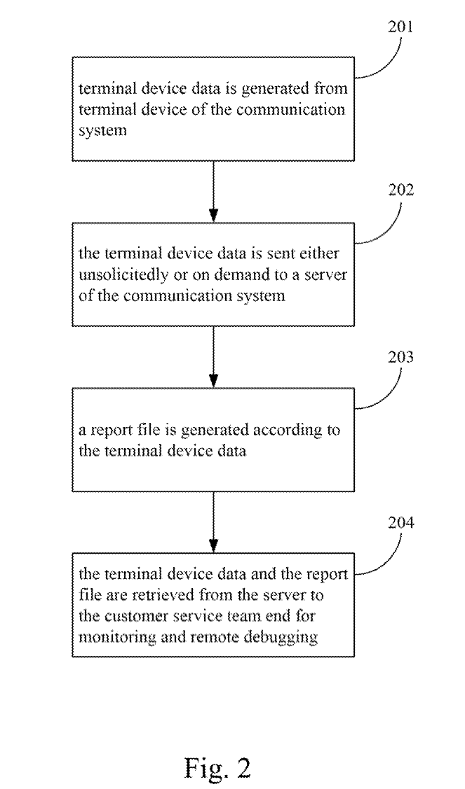

Another embodiment of the present disclosure is a method for monitoring is and remote debugging. The method can be adapted in the communication system 1 depicted in FIG. 1. Please refer to FIG. 2. FIG. 2 is a flow chart of the method for monitoring and remote debugging in the present embodiment. The method comprises the steps as follows. In step 201, terminal device data 11 is generated from terminal device 12 of the communication system 1. In step 202, the terminal device data 11 is sent either unsolicitedly or on demand to a server 10 of the communication system 1. In step 203, a report file 13 is generated according to the terminal device data 11. After receiving the terminal device data 11 or after generating the report file 13, the server 10 is able to notify the customer service team end 14. Then in step 204, the terminal device data 11 and the report file 13 are retrieved from the server 10 to the customer service team end 14 for monitoring and remote debugging.

In an embodiment, the customer service team end 14 is able to login to the server to send a command to the terminal device 12 to request terminal device 12 to send the terminal device data 11 to the server to further perform monitoring and remote debugging.

The present disclosure provides a communication system and a method adapted in the communication system for monitoring and remote debugging. The terminal device in the communication system is able to transfer the information such as time, location, usage events, computer environment, network quality measurement . . . etc. to the server. Therefore, the customer service team can retrieve the information as soon as possible to perform monitoring and remote debugging. Further, the customer service team can send commands to request the terminal devices to send the information to perform monitoring and remote debugging actively.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A communication system comprising:
a server;
at least one terminal device to generate a terminal device data, wherein the terminal device further sends the terminal device data either unsolicitedly or on demand to the server, wherein the server further generates a report file according to the terminal device data; and
a customer service team end to retrieve the terminal device data and the report file from the server for monitoring and remote debugging.

2. The communication system of claim 1, wherein the customer service team end is able to login to the server to control the terminal device by sending a command to the terminal device.

3. The communication system of claim 2, wherein the command is to request the terminal device to send the terminal device data to the server and to command the terminal device when start or stop generating terminal device data.

4. The communication system of claim 2, wherein the server sends the command to the terminal device through a dedicated signaling channel, a paging channel, a forward access channel or a shared access channel.

5. The communication system of claim 2, further comprising an SMS modem, wherein the server sends the command to the terminal device using SMS through the SMS modem.

6. The communication system of claim 1, further comprising an SMS modem, wherein the server further sends an SMS through the SMS modem to notify the customer service team end after the terminal device sends the terminal device data to the server.

7. The communication system of claim 1, wherein the terminal device data comprises a device information, a radio environment data, a plurality of user usage events, a measurement data, or a combination thereof, and the report file comprises a network performance analysis, a user behavior analysis, a usage analysis, a capacity analysis, or a combination thereof.

8. The communication system of claim 1, further comprising a data processor to generate a plurality of report files according to the terminal device data.

9. The communication system of claim 1, wherein the terminal device is to send the terminal device data to the server through a wireless network or a cable network.

10. The communication system of claim 1, wherein the terminal device supports WiFi, GSM, GPRS, WCDMA, HSPA, LTE, WiMax, CDMA2000, GPS, Ethernet network, or a combination thereof.

11. The communication system of claim 1, wherein the terminal device starts or stops to generate the terminal device data with an event-triggered mechanism.

12. The communication system of claim 11, wherein the terminal device sends to the server the terminal device data comprising data only within a period right before service events happen.

13. The communication system of claim 1, wherein the terminal device is a data modem, a handset, a mobile internet device, a notebook computer embedded with cellular function, a router embedded with cellular function or an M2M device.

14. A method adapted in a communication system for monitoring and remote debugging, wherein the method comprises the steps of:
generating a terminal device data from at least one terminal device of the communication system;
sending the terminal device data either unsolicitedly or on demand to a server of the communication system;
generating a report file according to the terminal device data; and
retrieving the terminal device data and the report file from the server to a customer service team end for monitoring and remote debugging.

15. The method of claim 14, further comprising a step of generating a plurality of report files according to the terminal device data.

16. The method of claim 14, after sending the terminal device data to the server further comprising a step of sending an SMS to notify the customer service team.

17. The method of claim 14, further comprising the steps of:
logging in to the server from the customer service team end;
sending a command to the terminal device; and
requesting the terminal device to send the terminal device data to the server.

18. The method of claim 17, wherein the command is sent to the terminal device using SMS or through a dedicated signaling channel, a paging channel, a forward access channel or a shared access channel.

19. The method of claim 14, wherein the terminal device data starts or stops to be generated with an event-triggered mechanism.

20. The method of claim 19, wherein the terminal device data starts or stops to be generated before an event happens.
